(19) United States
(12) Patent Application Publication
(10) Pub. No.: US 2012/0042767 A1
(43) Pub. Date: Feb. 23, 2012

(54) Method for guitar instruction

(76) Inventor: Richard Danford, North Hollywood, CA (US)

(21) Appl. No.: 12/806,774

(22) Filed: Aug. 20, 2010

(51) Int. Cl. G09B 15/06

(52) U.S. Cl. 84/485 R

(57) ABSTRACT

This invention concerns a business method by which improved instruction of advanced guitar playing is possible. String groupings and inversions on those string groupings are presented to the student in a way reflective of pattern, and of overall musical theory. Twenty inversions of the same chord are visible on the guitar neck at one time and the student is taught a schematic approach to recognize and play any of those chord inversions at will. This method is useful either by in-person instruction, online instruction, television, DVD, book, or other medium that can be monetized and produces the result that an advanced guitar player purchasing these instructions can rapidly achieve an elite understanding of guitar chords. Using this method, the student will understand how instantly to be able to play any chord possible on the guitar, at any position on the musical staff possible to the guitar, and with any particular note of that chord being the lowest note fingered on the guitar at a given time.

### CROSS REFERENCE TO RELATED APPLICATIONS

There are no related applications.

### STATEMENT REGARDING FEDERALLY SPONSORED RESEARCH AND DEVELOPMENT

This invention was not made using federally sponsored research and development. The inventor retains all rights.

### THE NAMES OF THE PARTIES TO A JOINT RESEARCH AGREEMENT

There is no joint research agreement that applies to this invention.

### REFERENCE TO A SEQUENCE LISTING

None

### BACKGROUND OF THE INVENTION

The guitar is a stringed musical instrument having a neck along which the strings are disposed in a parallel arrangement. The neck has a flat surface facing the strings and a series of frets (ridges perpendicular to the strings) on that flat surface which aid the player in fingering chords by pressing string groupings against the flat surface of the neck. Chords are groups of musical notes within an octave played simultaneously in such a manner as to represent one of the musical keys long known to the musical arts. A standard method of playing a chord might be to finger the first note of an octave together with the third note and the fifth note. An inversion would be playing the chord with a different note of the octave as the lowest played note. For example the chord could be played by playing the third note, the fifth note, and the eighth note of an octave. This inversion would be in the same key as the first described chord, but would present a variant sound to the ear of the listener leading to enhanced interest. Another inversion might be to play the fifth note and the eighth note together with the third note of the next higher octave. Using the hierarchy of possible octaves on a given instrument such as the guitar of this example allows the musician a range of possible chords and inversions that can be performed. In the past, these chords have been taught in a linear fashion with the result that years of painstaking effort and rote memorization are required for a student to master all the chords and inversions possible on the guitar. This leads to frustration and the student eventually reaches a plateau beyond which no further learning is possible.

### BRIEF SUMMARY OF THE INVENTION.

This invention concerns a business method by which improved instruction of advanced guitar playing is possible. String groupings and inversions on those string groupings are presented to the student in a way reflective of pattern, and of overall musical theory. Twenty inversions of the same chord are visible on the guitar neck at one time and the student is taught a schematic approach to recognize and play any of those chord inversions at will, even if the student had not previously known of that inversion at that position of the musical staff. This method is useful either by in-person instruction, online instruction, television, DVD, book, or other medium that can be monetized and produces the result that an advanced guitar player purchasing these instructions can rapidly achieve an elite understanding of guitar chords. Using this method, the student will understand how instantly to be able to play any chord possible on the guitar, at any position on the musical staff possible to the guitar, and with any particular note of that chord being the lowest note fingered on the guitar at a given time. What the player decides to play can instantly be fingered correctly and played.

### BRIEF DESCRIPTION OF THE SEVERAL VIEWS OF THE DRAWINGS.

FIG. 1 is a diagram of a guitar neck showing a D Major chord inverted three times.

FIG. 2 is a diagram of a guitar neck showing a chord that contains the notes A, C, E, & F#. (These notes spell out an A6th chord.)

FIG. 3 is a diagram of a guitar neck showing a chord that contains the notes F#, A, C & E. (These notes spell out F# minor 7).

FIG. 4 is a diagram of a guitar neck showing a D major triad inverted twice showing three ways to play the chord on the same set of strings. (strings 1, 2 & 3)

FIG. 5 is a diagram of a guitar neck showing the D major triad inverted twice showing three ways to play the chord on the same set of strings. (strings 2, 3 & 4)

FIG. 6 is a diagram of a guitar neck showing the D major triad inverted twice showing three ways to play the chord on the same set of strings. (strings 3, 4 & 5)

FIG. 7 is a diagram of a guitar neck showing the D major triad inverted twice showing three ways to play the chord on the same set of strings. (strings 4, 5, & 6)

FIG. 8 is a diagram of a guitar neck showing a mental awareness technique to visualize string groupings.

FIG. 9 is a diagram of a guitar neck showing a mental awareness technique to visualize string groupings.

FIG. 10 is a diagram of a guitar neck showing a mental awareness technique to visualize string groupings.

FIG. 11 is a diagram of a guitar neck showing a mental awareness technique to visualize string groupings.

FIG. 12 is a diagram of a guitar neck showing a diatonic stream learning technique.

FIG. 13 is a diagram of a guitar neck showing a diatonic stream learning technique on a different set of strings.

FIG. 14 is a diagram of a guitar neck showing a diatonic stream learning technique on a different set of strings.

FIG. 15 is a diagram of a guitar neck showing a diatonic stream learning technique on a different set of strings.

FIG. 16 is a diagram of a section of a guitar neck showing the beginning of a succession of chords that can be played in an order known as a “progression” that would simulate a song condition.

FIG. 17 is a diagram of a section of a guitar neck showing one execution of a succession of chords that can be played in an order known as a “progression” that would simulate a song condition.

FIG. 18 is a diagram of a section of a guitar neck showing one execution of a succession of chords that can be played in an order known as a “progression” that would simulate a song condition.

FIG. 19 is a diagram of a section of a guitar neck showing one execution of a succession of chords that can be played in an order known as a “progression” that would simulate a song condition.

FIG. 20 is a diagram of a section of a guitar neck showing one execution of a succession of chords that can be played in an order known as a “progression” that would simulate a song condition.

FIG. 21-A shows an example of an inversion of a dominant 7^{th} chord

FIG. 21-B shows an example of an inversion of a dominant 7^{th} chord

FIG. 21-C shows an example of an inversion of a dominant 7^{th} chord

FIG. 21-D shows an example of an inversion of a dominant 7^{th} chord

FIG. 21-E shows an example of an inversion of a dominant 7^{th} chord

FIG. 21-F shows an example of an inversion of a dominant 7^{th} chord

FIG. 21-G shows an example of an inversion of a dominant 7^{th} chord

FIG. 21-H shows an example of an inversion of a dominant 7^{th} chord

FIG. 21-I shows an example of an inversion of a dominant 7^{th} chord

FIG. 21-J shows an example of an inversion of a dominant 7^{th} chord

FIG. 21-K shows an example of an inversion of a dominant 7^{th} chord

FIG. 21-L shows an example of an inversion of a dominant 7^{th} chord

FIG. 22 is a diagram of an exercise where the root is played on a different string each time.

FIG. 23 is a diagram of an exercise where the root is played on a different string each time.

FIG. 24 is a diagram of an exercise where the root is played on a different string each time.

FIG. 25 is a diagram of a guitar neck showing a cycle of keys the student can play within a few frets of each other.

FIG. 26 is a diagram of a guitar neck showing a chord on the 5 string sets and all of its inversions with one root focus.

FIG. 27 is a diagram of a guitar neck showing a chord on the 5 string sets and all of its inversions with one root focus.

FIG. 28 is a diagram of a guitar neck showing a chord on the 5 string sets and all of its inversions with one root focus.

FIG. 29 is a diagram of a guitar neck showing a chord on the 5 string sets and all of its inversions with one root focus.

FIG. 30 is a diagram of a guitar neck showing a chord on the 5 string sets and all of its inversions with one root focus.

FIG. 31 is a diagram of a guitar neck showing a chord on the 5 string sets and all of its inversions with two root focuses.

FIG. 32 is a diagram of a guitar neck showing a chord on the 5 string sets and all of its inversions with two root focuses.

FIG. 33 is a diagram of a guitar neck showing a chord on the 5 string sets and all of its inversions with two root focuses.

FIG. 34 is a diagram of a guitar neck showing a chord on the 5 string sets and all of its inversions with two root focuses.

FIG. 35 is a diagram of a guitar neck showing a chord on the 5 string sets and all of its inversions with two root focuses.

FIG. 36 is a diagram of a guitar neck showing a chord on the 5 string sets and all of its inversions with three root focuses.

FIG. 37 is a diagram of a guitar neck showing a chord on the 5 string sets and all of its inversions with three root focuses.

FIG. 38 is a diagram of a guitar neck showing a chord on the 5 string sets and all of its inversions with three root focuses.

FIG. 39 is a diagram of a guitar neck showing a chord on the 5 string sets and all of its inversions with three root focuses.

FIG. 40 is a diagram of a guitar neck showing a chord on the 5 string sets and all of its inversions with three root focuses.

FIG. 41 is a diagram of a guitar neck showing a chord on the 5 string sets and all of its inversions with eight root focuses.

FIG. 42 is a diagram of a guitar neck showing a chord on the 5 string sets and all of its inversions with eight root focuses.

FIG. 43 is a diagram of a guitar neck showing a chord on the 5 string sets and all of its inversions with eight root focuses.

FIG. 44 is a diagram of a guitar neck showing a chord on the 5 string sets and all of its inversions with eight root focuses.

FIG. 45 is a diagram of a guitar neck showing a chord on the 5 string sets and all of its inversions with eight root focuses.

FIG. 46 is a diagram of a guitar neck showing a chord on the 5 string sets and all of its inversions with eight root focuses.

FIG. 47 is a diagram of a guitar neck showing a chord on the 5 string sets and all of its inversions with eight root focuses.

FIG. 48 is a diagram of a guitar neck showing a chord on the 5 string sets and all of its inversions with eight root focuses.

FIG. 49 is a diagram of a guitar neck showing a chord on the 5 string sets and all of its inversions with eight root focuses.

FIG. 50 is a diagram of a guitar neck showing a chord on the 5 string sets and all of its inversions with eight root focuses.

FIG. 51 is a diagram of a guitar neck showing a chord on the 5 string sets and all of its inversions with eight root focuses.

FIG. 52 is a diagram of a guitar neck showing a chord on the 5 string sets and all of its inversions with eight root focuses.

FIG. 53 is a diagram of a guitar neck showing a chord on the 5 string sets and all of its inversions with eight root focuses.

FIG. 54 is a diagram of a guitar neck showing a chord on the 5 string sets and all of its inversions with eight root focuses.

FIG. 55 is a diagram of a guitar neck showing a chord on the 5 string sets and all of its inversions with eight root focuses.

FIG. 56 is a diagram of a guitar neck showing a chord on the 5 string sets and all of its inversions with eight root focuses.

FIG. 57 is a diagram of a guitar neck showing a chord on the 5 string sets and all of its inversions with eight root focuses.

FIG. 58 is a diagram of a guitar neck showing a chord on the 5 string sets and all of its inversions with eight root focuses.

FIG. 59 is a diagram of a guitar neck showing a chord on the 5 string sets and all of its inversions with eight root focuses.

FIG. 60 is a diagram of a guitar neck showing a chord on the 5 string sets and all of its inversions with eight root focuses.

FIG. 61 shows a dominant 7^{th} chord on the five string sets.

FIG. 61-A shows a dominant 7^{th} chord on the five string sets.

FIG. 61-B shows a dominant 7^{th} chord on the five string sets.

FIG. 61-C shows a dominant 7^{th} chord on the five string sets.

FIG. 61-D shows a dominant 7^{th} chord on the five string sets.

FIG. 62 shows a dominant 7^{th} chord on the five string sets.

FIG. 62-A shows a dominant 7^{th} chord on the five string sets.

FIG. 62-B shows a dominant 7^{th} chord on the five string sets.

FIG. 62-C shows a dominant 7^{th} chord on the five string sets.

FIG. 62-D shows a dominant 7^{th} chord on the five string sets.

FIG. 63 shows a dominant 7^{th} chord on the five string sets.

FIG. 63-A shows a dominant 7^{th} chord on the five string sets.

FIG. 63-B shows a dominant 7^{th} chord on the five string sets.

FIG. 63-C shows a dominant 7^{th} chord on the five string sets.

FIG. 63-D shows a dominant 7^{th} chord on the five string sets.

FIG. 64 shows a dominant 7^{th} chord on the five string sets.

FIG. 64-A shows a dominant 7^{th} chord on the five string sets.

FIG. 64-B shows a dominant 7^{th} chord on the five string sets.

FIG. 64-C shows a dominant 7^{th} chord on the five string sets.

FIG. 64-D shows a dominant 7^{th} chord on the five string sets.

FIG. 65 shows a dominant 7^{th} chord on the five string sets.

FIG. 65-A shows a dominant 7^{th} chord on the five string sets.

FIG. 65-B shows a dominant 7^{th} chord on the five string sets.

FIG. 65-C shows a dominant 7^{th} chord on the five string sets.

FIG. 65-D shows a dominant 7^{th} chord on the five string sets.

FIG. 66 shows a dominant 7^{th} chord on the five string sets.

FIG. 66-A shows a dominant 7^{th} chord on the five string sets.

FIG. 66-B shows a dominant 7^{th} chord on the five string sets.

FIG. 66-C shows a dominant 7^{th} chord on the five string sets.

FIG. 66-D shows a dominant 7^{th} chord on the five string sets.

FIG. 67 shows a dominant 7^{th} chord on the five string sets.

FIG. 67-A shows a dominant 7^{th} chord on the five string sets.

FIG. 67-B shows a dominant 7^{th} chord on the five string sets.

FIG. 67-C shows a dominant 7^{th} chord on the five string sets.

FIG. 67-D shows a dominant 7^{th} chord on the five string sets.

FIG. 68 shows a dominant 7^{th} chord on the five string sets.

FIG. 68-A shows a dominant 7^{th} chord on the five string sets.

FIG. 68-B shows a dominant 7^{th} chord on the five string sets.

FIG. 68-C shows a dominant 7^{th} chord on the five string sets.

FIG. 68-D shows a dominant 7^{th} chord on the five string sets.

FIG. 69 shows a dominant 7^{th} chord on the five string sets.

FIG. 69-A shows a dominant 7^{th} chord on the five string sets.

FIG. 69-B shows a dominant 7^{th} chord on the five string sets.

FIG. 69-C shows a dominant 7^{th} chord on the five string sets.

FIG. 69-D shows a dominant 7^{th} chord on the five string sets.

FIG. 70 shows a dominant 7^{th} chord on the five string sets.

FIG. 70-A shows a dominant 7^{th} chord on the five string sets.

FIG. 70-B shows a dominant 7^{th} chord on the five string sets.

FIG. 70-C shows a dominant 7^{th} chord on the five string sets.

FIG. 70-D shows a dominant 7^{th} chord on the five string sets.

FIG. 71 shows a dominant 7^{th} chord on the five string sets.

FIG. 71-A shows a dominant 7^{th} chord on the five string sets.

FIG. 71-B shows a dominant 7^{th} chord on the five string sets.

FIG. 71-C shows a dominant 7^{th} chord on the five string sets.

FIG. 71-D shows a dominant 7^{th} chord on the five string sets.

FIG. 72 shows a dominant 7^{th} chord on the five string sets.

FIG. 72-A shows a dominant 7^{th} chord on the five string sets.

FIG. 72-B shows a dominant 7^{th} chord on the five string sets.

FIG. 72-C shows a dominant 7^{th} chord on the five string sets.

FIG. 72-D shows a dominant 7^{th} chord on the five string sets.

FIG. 73 shows a dominant 7^{th} chord on the five string sets.

FIG. 73-A shows a dominant 7^{th} chord on the five string sets.

FIG. 73-B shows a dominant 7^{th} chord on the five string sets.

FIG. 73-C shows a dominant 7^{th} chord on the five string sets.

FIG. 73-D shows a dominant 7^{th} chord on the five string sets.

FIG. 74 shows a dominant 7^{th} chord on the five string sets.

FIG. 74-A shows a dominant 7^{th} chord on the five string sets.

FIG. 74-B shows a dominant 7^{th} chord on the five string sets.

FIG. 74-C shows a dominant 7^{th} chord on the five string sets.

FIG. 74-D shows a dominant 7^{th} chord on the five string sets.

FIG. 75 shows a dominant 7^{th} chord on the five string sets.

FIG. 75-A shows a dominant 7^{th} chord on the five string sets.

FIG. 75-B shows a dominant 7^{th} chord on the five string sets.

FIG. 75-C shows a dominant 7^{th} chord on the five string sets.

FIG. 75-D shows a dominant 7^{th} chord on the five string sets.

FIG. 76 shows a dominant 7^{th} chord on the five string sets.

FIG. 76-A shows a dominant 7^{th} chord on the five string sets.

FIG. 76-B shows a dominant 7^{th} chord on the five string sets.

FIG. 76-C shows a dominant 7^{th} chord on the five string sets.

FIG. 76-D shows a dominant 7^{th} chord on the five string sets.

FIG. 77 shows a dominant 7^{th} chord on the five string sets.

FIG. 77-A shows a dominant 7^{th} chord on the five string sets.

FIG. 77-B shows a dominant 7^{th} chord on the five string sets.

FIG. 77-C shows a dominant 7^{th} chord on the five string sets.

FIG. 77-D shows a dominant 7^{th} chord on the five string sets.

FIG. 78 shows a dominant 7^{th} chord on the five string sets.

FIG. 78-A shows a dominant 7^{th} chord on the five string sets.

FIG. 78-B shows a dominant 7^{th} chord on the five string sets.

FIG. 78-C shows a dominant 7^{th} chord on the five string sets.

FIG. 78-D shows a dominant 7^{th} chord on the five string sets.

FIG. 79 shows a dominant 7^{th} chord on the five string sets.

FIG. 79-A shows a dominant 7^{th} chord on the five string sets.

FIG. 79-B shows a dominant 7^{th} chord on the five string sets.

FIG. 79-C shows a dominant 7^{th} chord on the five string sets.

FIG. 79-D shows a dominant 7^{th} chord on the five string sets.

FIG. 80 shows a dominant 7^{th} chord on the five string sets.

FIG. 80-A shows a dominant 7^{th} chord on the five string sets.

FIG. 80-B shows a dominant 7^{th} chord on the five string sets.

FIG. 80-C shows a dominant 7^{th} chord on the five string sets.

FIG. 80-D shows a dominant 7^{th} chord on the five string sets.

FIG. 81 shows an “open” major chord containing a muted 3^{rd}.

### DETAILED DESCRIPTION OF THE INVENTION

This invention concerns a business method by which improved instruction of advanced guitar playing is possible. String groupings and inversions on those string groupings are presented to the student in a way reflective of pattern, and of overall musical theory.

A “closed triad” will give you 12 inversions on 4 sets of strings, 3 inversions on each string set.

An “open triad” will give you 15 inversions on 5 sets of strings, 3 inversions on each string set.

A “four note” chord will give you 20 inversions on 5 sets of strings, 4 inversions on each string set.

All of the inversions of a particular chord are visible on the guitar neck at any one time and the student is taught a schematic approach to recognize and play any of those chord inversions at will. This method is useful either by in-person instruction, online instruction, television, DVD, book, or other medium that can be monetized and produces the result that an advanced guitar player purchasing these instructions can rapidly achieve an elite understanding of guitar chords. Using this method, the student will understand how instantly to be able to play any chord possible on the guitar, at any position on the musical staff possible to the guitar, and with any particular note of that chord being the lowest note fingered on the guitar at a given time. As the chord inverts, the chord tones will shift from bass to alto to tenor to soprano to bass etc. depending on which direction the student moves, and which inversion the student chooses to play.

In the figures when a group of fingering positions is circled with a dotted line, that means that the circled group of dots is a chord. When an individual note dot is an open circle that is surrounded by a dotted line, that means that dot would not be show in the text book or on the computer screen of a computer interactive course (because the student will be prompted to supply that information as a learning exercise, test, or quiz). In an interactive computer version the student could perhaps click at the point he or she thinks is correct and then a new window appears explaining whether the choice was correct or incorrect and why. In a physical text book, the student would instead be expected to draw the dot where he or she thinks it goes.

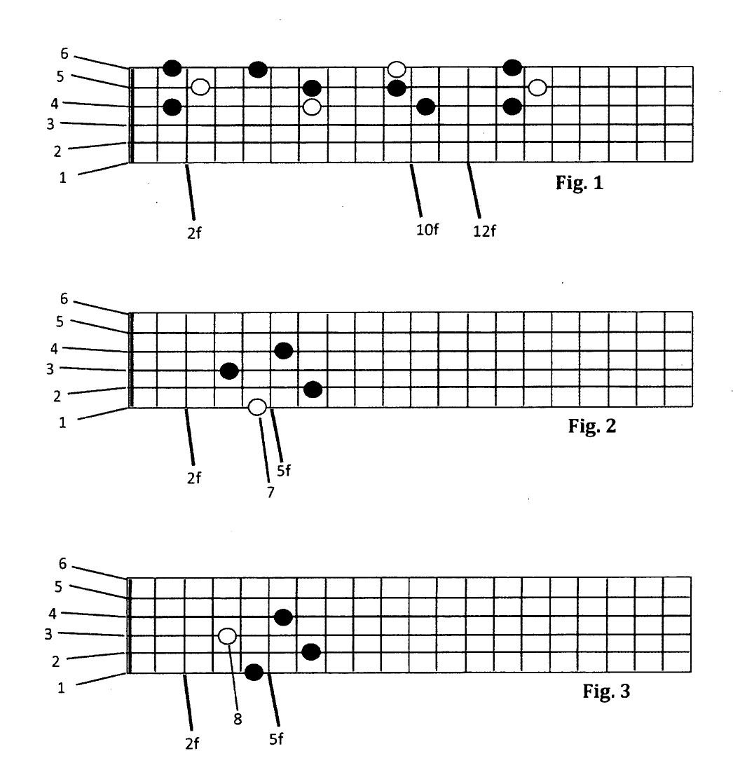

The inversion rule used to implement the method can be seen at FIG. 1. (This figure is shown for the purpose of describing the overall inversion rule principle where each chord tone moves up the guitar neck “in tone” to create the new inversion.) The strings of the guitar are the low E string (1), the A string (2), the D string (3), the G string (4), the B string (5), and the high E string (6). As a convention, where a reference numeral is followed by the letter “f′ that lead line designates a fret on the guitar neck. The second fret (2f), the tenth fret (10f), and the twelfth fret (12f) are shown in FIG. 1. The different ways to play the D major triads are separated into four groups of strings. Group 1 uses strings E, A, & D. Group 2 uses strings A, D. & G. Group 3 uses strings D, G, & B. Group four (seen at FIG. 1) uses strings G (4), B (5), & high E (6). By staying on the same set of strings the student can move each chord tone to the next chord tone and have the new inversion. FIG. 1 represents a sectional view of a continuous fretboard. The fourth chord is the octave, or a repeat of the first shape. As an example the D major chord has three chord tones (D, F#, and A). Using the inversion rule, to move up the fretboard the D will move up to the F# which is the next chord tone. The F# will move to its next chord tone which is A. Finally, the A will move up to the next chord tone which is D. Chord 1 inverts to chord 2. Chord 2 inverts to chord 3 and so on. Thus the student can play the same chord with a different sound. Due to the intuitively organized teaching method presented by this invention, the student has a way smoothly to move to the next inversion using the inversion rule rather than having had to memorize the fingering of each inversion by rote. The inversion rule applies to all chords. While it is possible to play all chords and their inversions on a piano because ten fingers are employed, only four fingers are employed to finger chords on a guitar. Some exotic chords can therefore only be played in one or two places on particular sets of strings because human fingers can only stretch so far. Looking at FIG. 1, a total of twelve frets can be seen as the span of an octave for any note or chord. The first chord shown centers around the second fret (2f). It's next higher inversion centers around the 5^{th} fret. The next inversion centers around the tenth fret (10f). The octave of the original chord centers around the 14^{th} fret. At this octave point, twelve frets higher, the same shape or fingering pattern is repeated as was seen at the lowermost fret. Going above or below that octave the inversions also are fingered by the same shapes in the same order as seen below. This method invention is a matter of presenting these patterns to the student in an intuitive and organized fashion for vastly accelerated learning of the chords possible on a guitar. The student will be able to envision and be aware of the chords along the entire guitar neck at all times. Other adjacent variations of any chord being played will simultaneously be in the awareness of the student so at any time the student can shift to one of the variations adding change and interest to the song without changing the basic chord being played. The student gains enhanced confidence and no longer feels overwhelmed with information as happens with the rote memorization used in the past.

FIGS. 2 and 3 show how the same fingering shape of a chord can have a different root focus. In these examples, the root of each chord is shown by an open circle while the finger position of the other notes is shown by a closed circle. To make the A6th chord seen in FIG. 2, the A note (7) fingered at fret 5 (5f) is the focus. To make the F#m7 chord seen in FIG. 3, the F# note (8) is the focus. Both Fig. and FIG. 3 contain the same notes and the same shape. If a song asks for an A6 chord, you can play this shape. If a song calls for an F#m7 you can play this same shape. In effect, this is the same notes and same shape but focusing on a different note to serve as the “root” (A or F#).

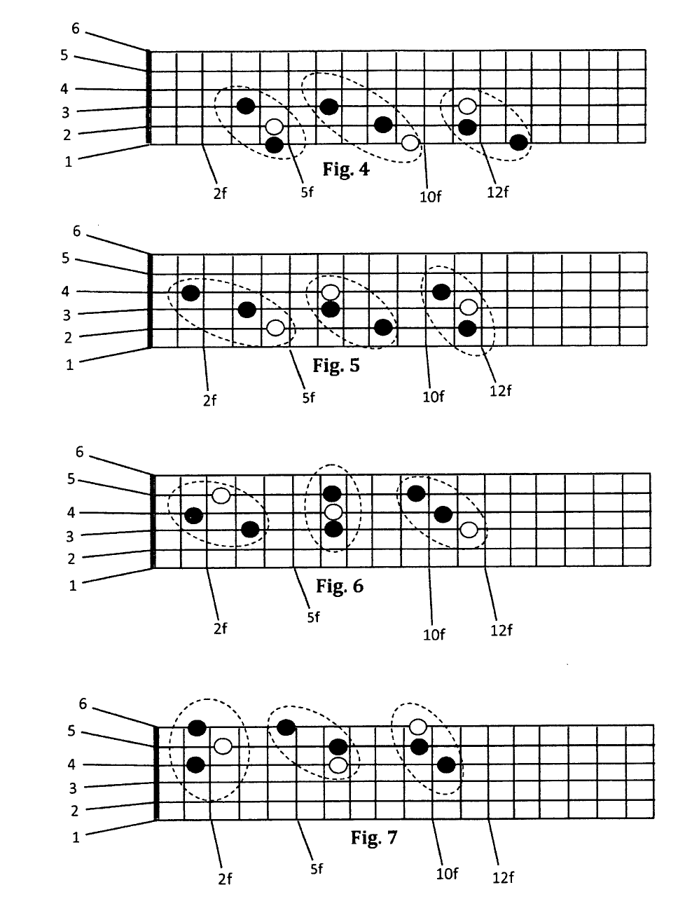

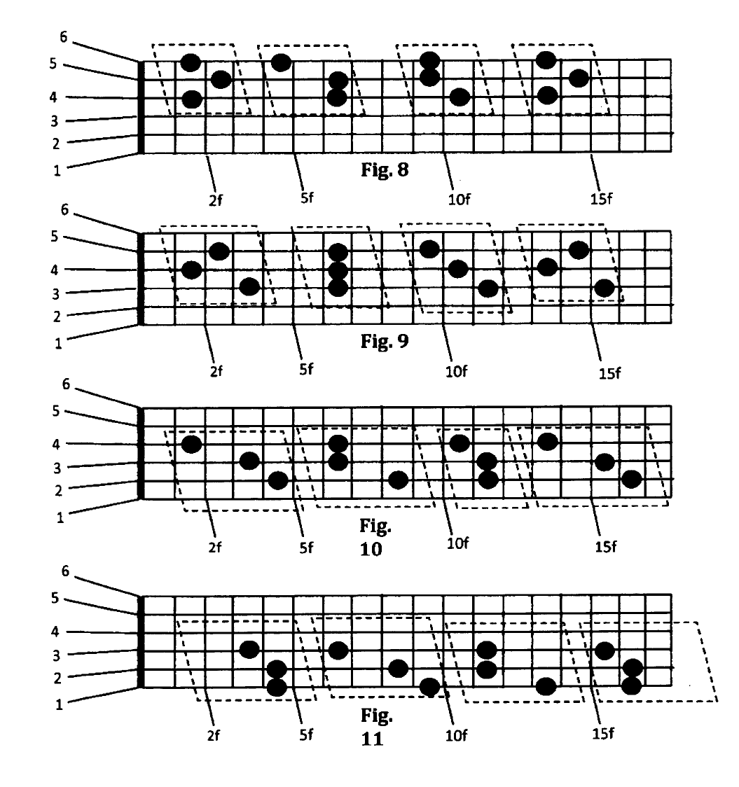

FIG. 4 has a group of fingering positions circled with a dotted line. FIGS. 4-7 show the pattern teaching method as it is applied to closed triads in D major. FIGS. 8-11 then show further the shape teaching method for triads.

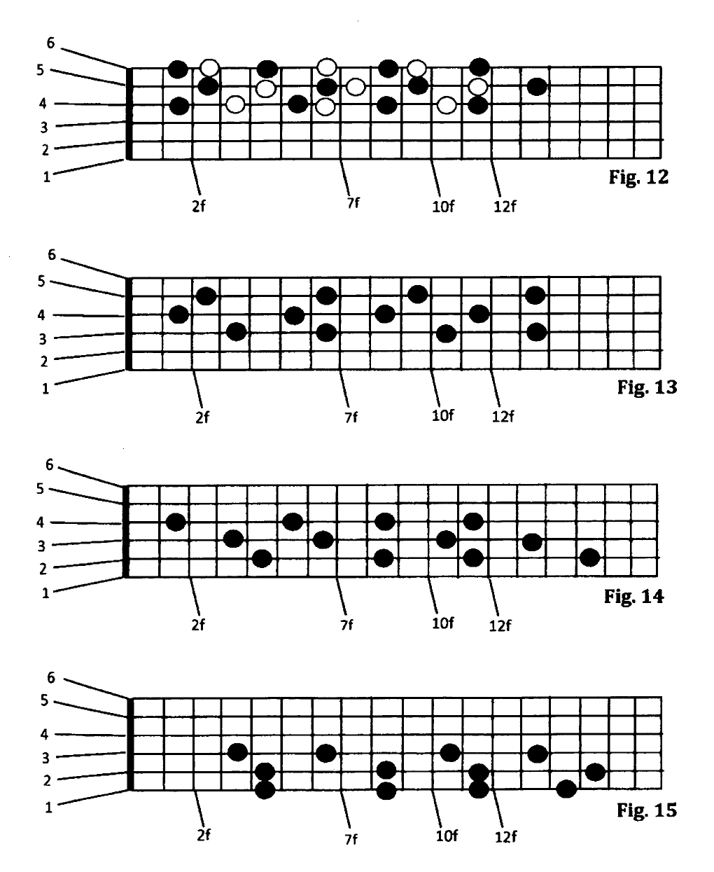

In FIG. 12 the black notes represent D major, F# minor, A major, and C# diminished. The student is required to know and notate the notes to show E minor, G major, and B minor. Thus, the student completes the D major diatonic scale on strings 4, 5, and 6. FIGS. 13-15 show examples of exercises that can be used where the student is required to fill in the missing chords (diatonic triads) with a pencil. This causes the student to be able to recognize and use the shapes.

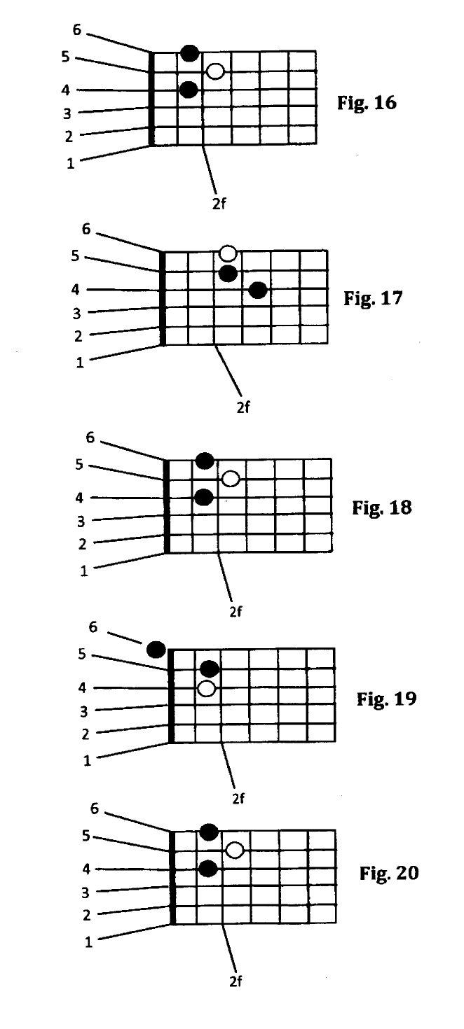

FIG. 16-20 are diagrams of a section of a guitar neck showing an example of how a succession of chords can be played in an order known as a “progression” that would simulate a song condition. There is a numerical description given to the progression. And that numerical description (representing the diatonic degree of the scale that they represent) is I, IV, I, V, I. The I (D major) is represented by FIG. 16. The IV (G major) is FIG. 17. The I (D major) is FIG. 18. The V (A major) is Figure is FIG. 19. String (6) in FIG. 20 is played but not fingered because it is an open string in that chord. The I (D major) is FIG. 20.

The method of instruction just described as to groupings of three strings would then be applied in the same fashion to teach the student “four note” chords, lying on four strings. The only limit to the numbers of string groupings that can be taught with this method is actually the limit imposed by the number of fingers on the human hand. This method presents students with chords that are foundational in that the chords can be altered by moving a single finger on one of the predetermined strings or by adding a new note on an additional string (once the student is familiarized with the possibility of such changes as a result of this teaching method). The result is the student is now given a springboard to embellish, alter, customize or enhance in a confident manner the foundational chords taught without having to resort to a reference book before doing so. The chord foundations have been imprinted into the student's memory bank for quicker access and use. That's how the intermediate guitar player is transformed into an advanced guitar player in a time frame that has been compressed by the efficiency of this teaching method. Another way to word the real world result of this teaching method is to say, “That is how a beginning professional guitar player is quickly taught to become a polished professional guitarist in demand.”

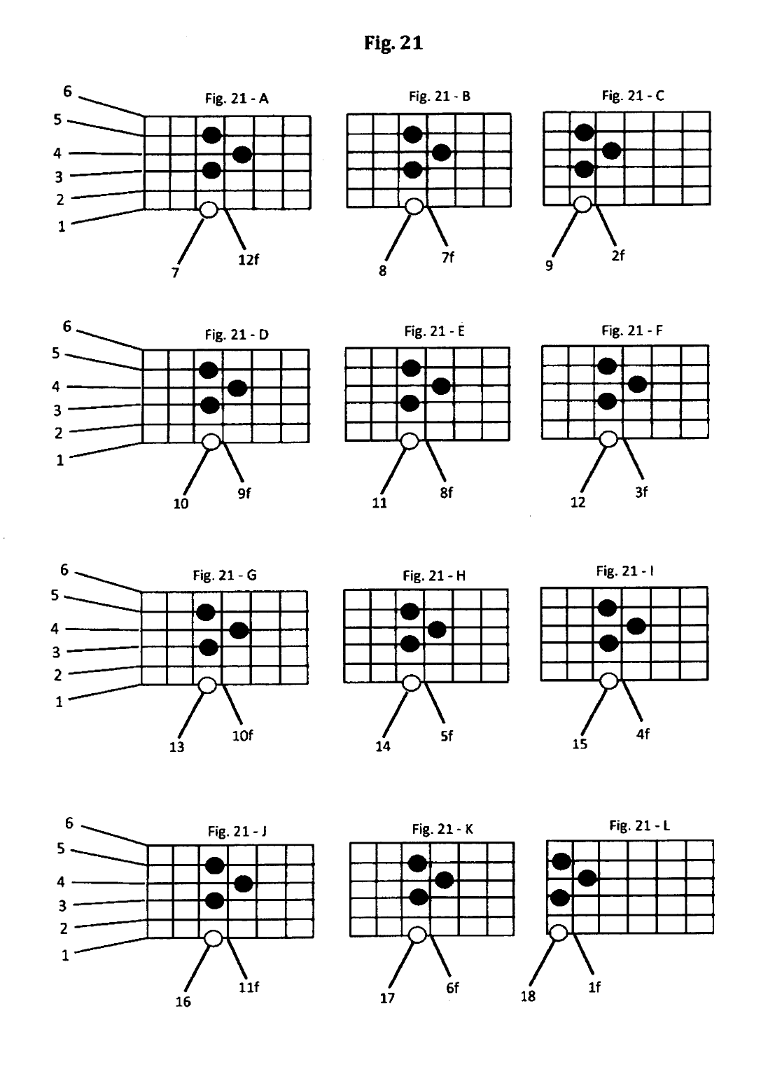

FIG. 21 shows the technique “practicing in cycles”which is stressed throughout this teaching method. Practicing in cycles is used to help the student consume and memorize all the various chord values, shapes, and particular characteristics of those chords in a rapid and efficient manner. This method comes in 4 or 5 stages depending on which chords are being studied by the student.

Step 1: FIG. 21 has 12 sub-figures, 21-A through 21-L. These sub-figures show the first of 4 inversions of a dominant 7^{th} chord on 12 different places of the guitar neck, all having the same shape, and all lying on the same set of strings. The “white dot” represents the “root” or “name” of that chord depending on which fret that root lies. As the student plays this same shape through a “cycle of keys,” he or she learns to focus on string #1. String #1 will always indicate the “root” or “name” of that chord when playing that particular shape. If the student is playing on the 12^{th} fret, it is called an E7 chord. If the student is playing on the 7^{th} fret it is called a B7 chord, etc.

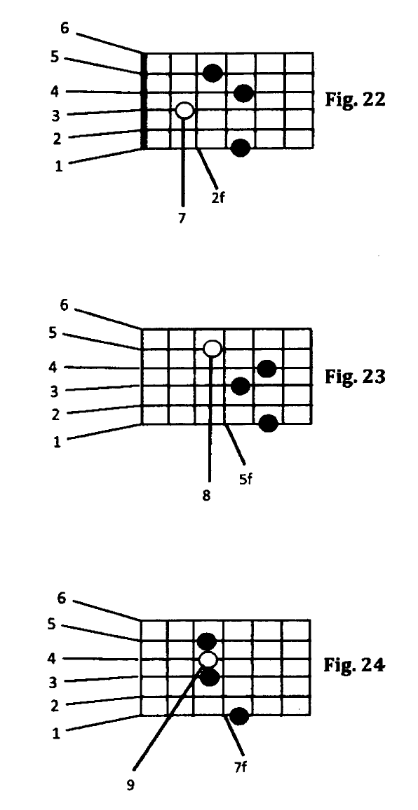

Steps 2, 3, and 4: Once the student is comfortable with playing the chord shapes in step 1, the same procedure will be followed for FIG. 22 and its associated sub-figures, FIG. 23 and its associated sub-figures, and FIG. 24 with its associated sub-figures. Each time the student attempts a new figure in this group, the “root” (white dot) will lie on a new string position throughout that cycle of keys.

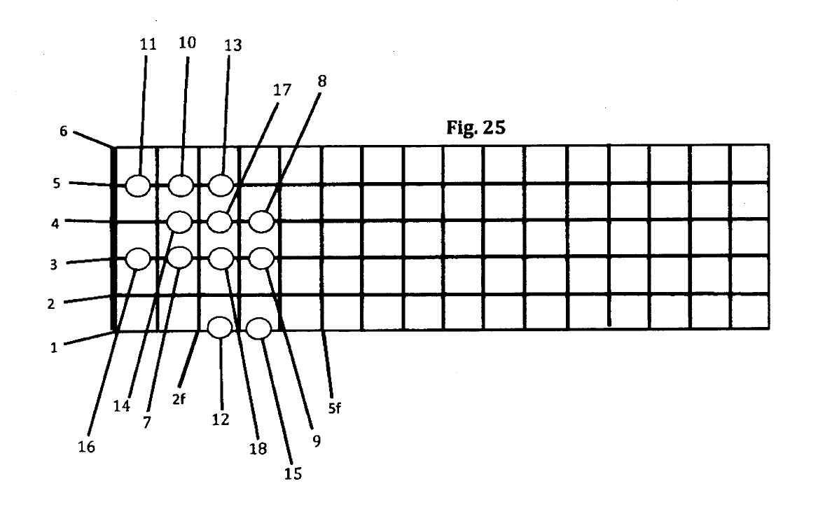

In FIG. 25 now that the student has become comfortable playing all four individual inversions through a cycle of keys, he or she now has the ability to stay in one position on the guitar moving one or two frets in either direction using all four inversions in the same exercise to play through a cycle of keys shown in FIG. 25 (which are 12 in total). Now the student has been given the opportunity to take advantage of this new drill method, using all 4 inversions, changing “string root focus” with each chord change, and not having to move an extreme distance as in the first four preliminary inversion exercises.

The student will be able to envision all root changes in a concentrated area.

As chords have different values such as major, minor, diminished, etc., the “root” location always remains constant regardless of any notes altered within the chord. Hence the “root focus” technique becomes a universal honing device to serve as a road map for the student no matter what chord the student is attempting to play.

This ability of envisioning multiple patterns “in layers” is essential for the guitar student that desires a wider and more technologically advanced chord vocabulary as well as a greater chance to be sought after for professional opportunities. If the student has a desire to learn and play “blues” or “jazz” oriented pieces, this learning method is even more critical.

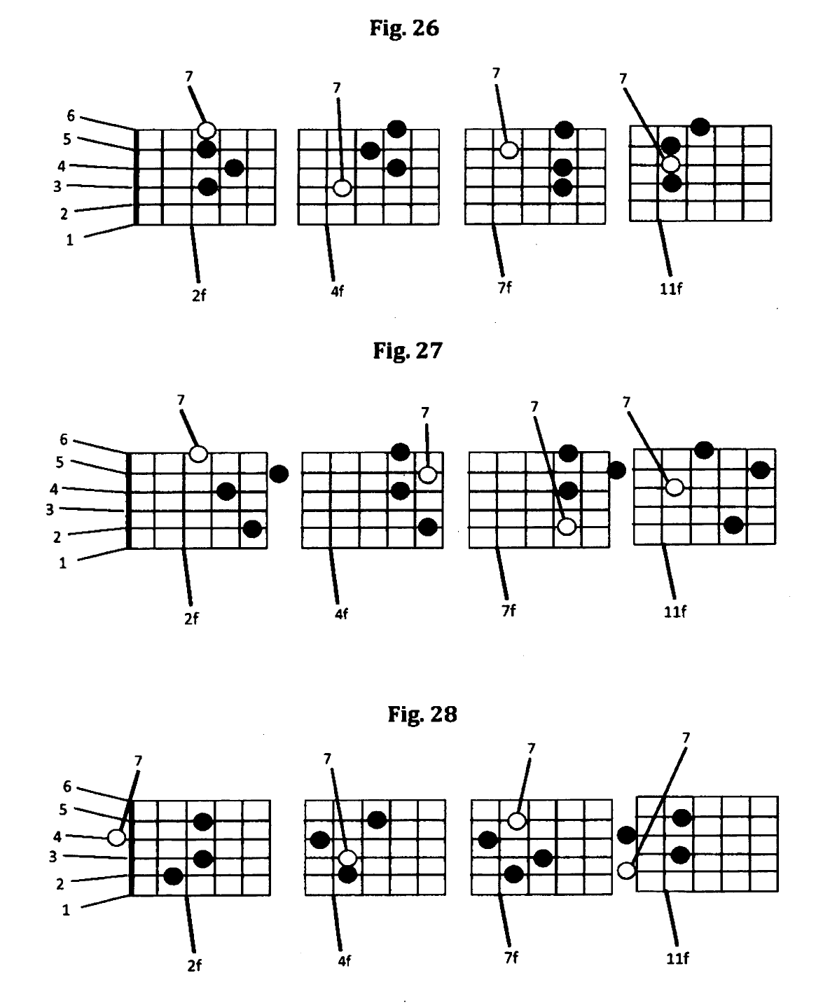

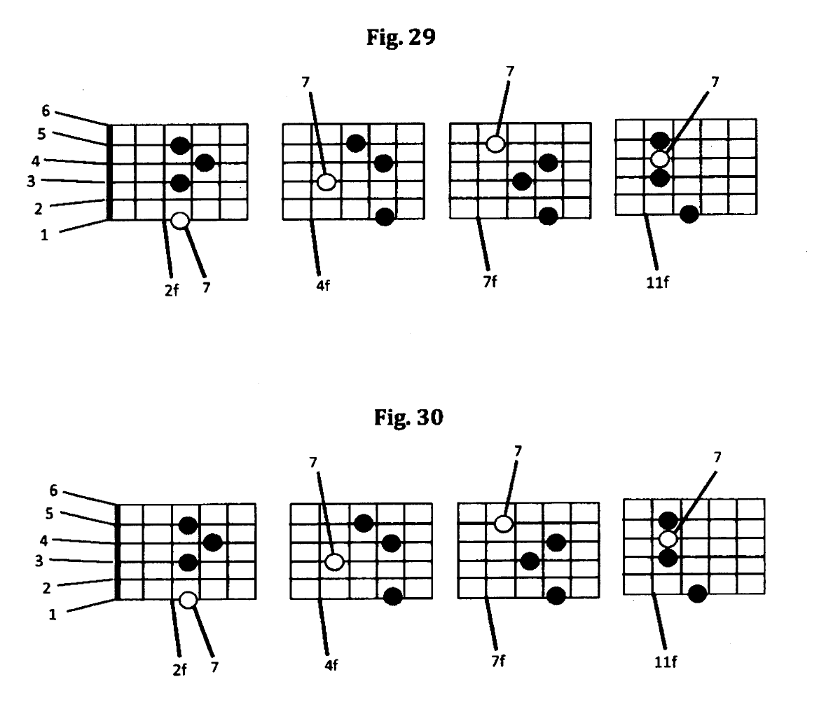

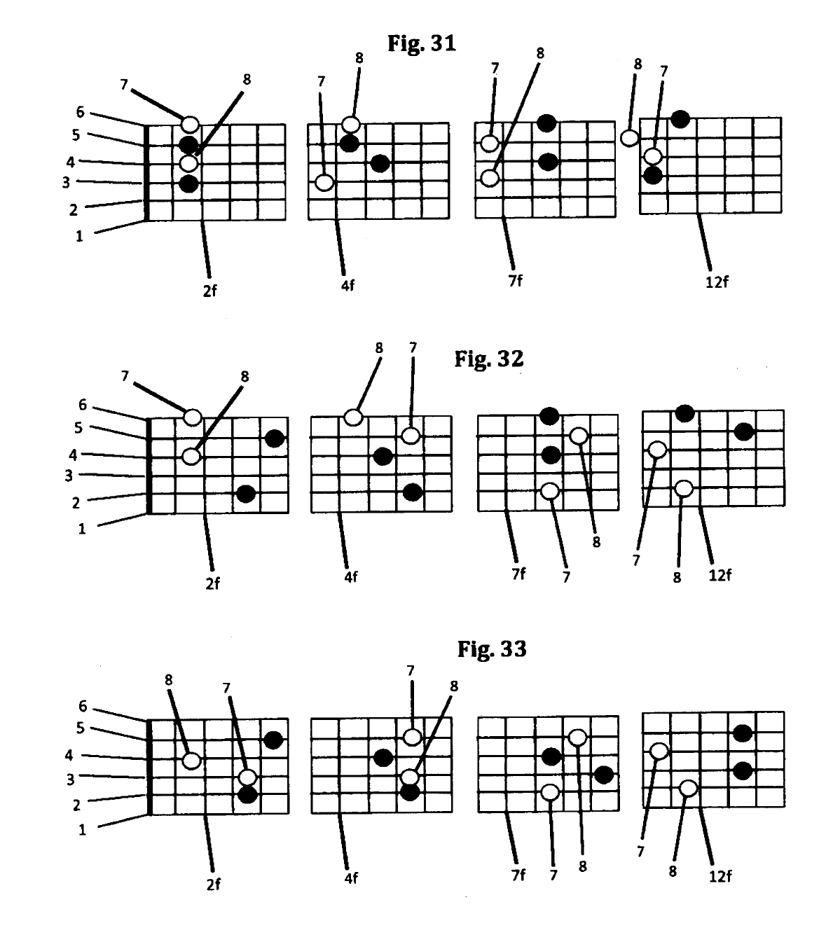

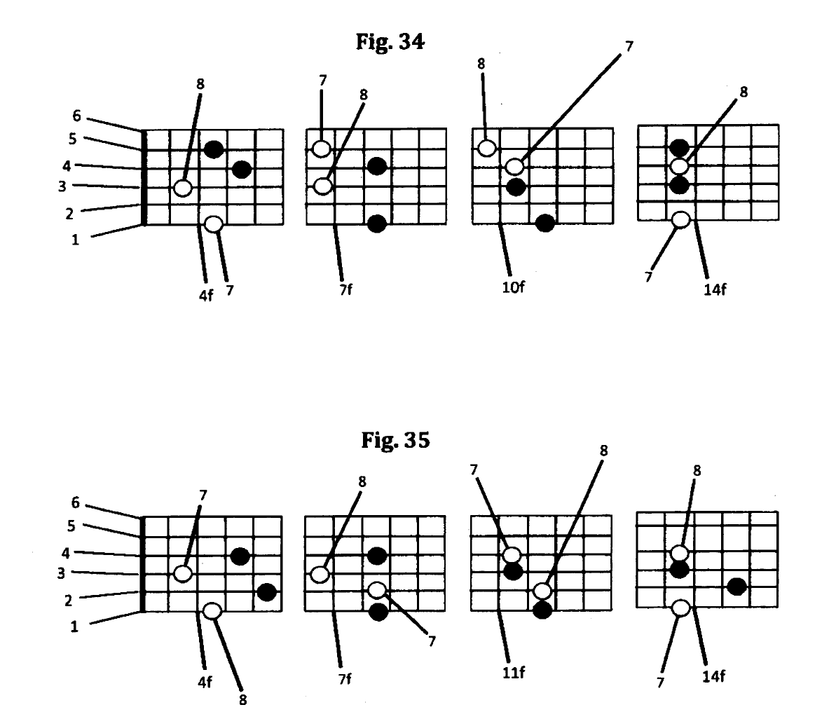

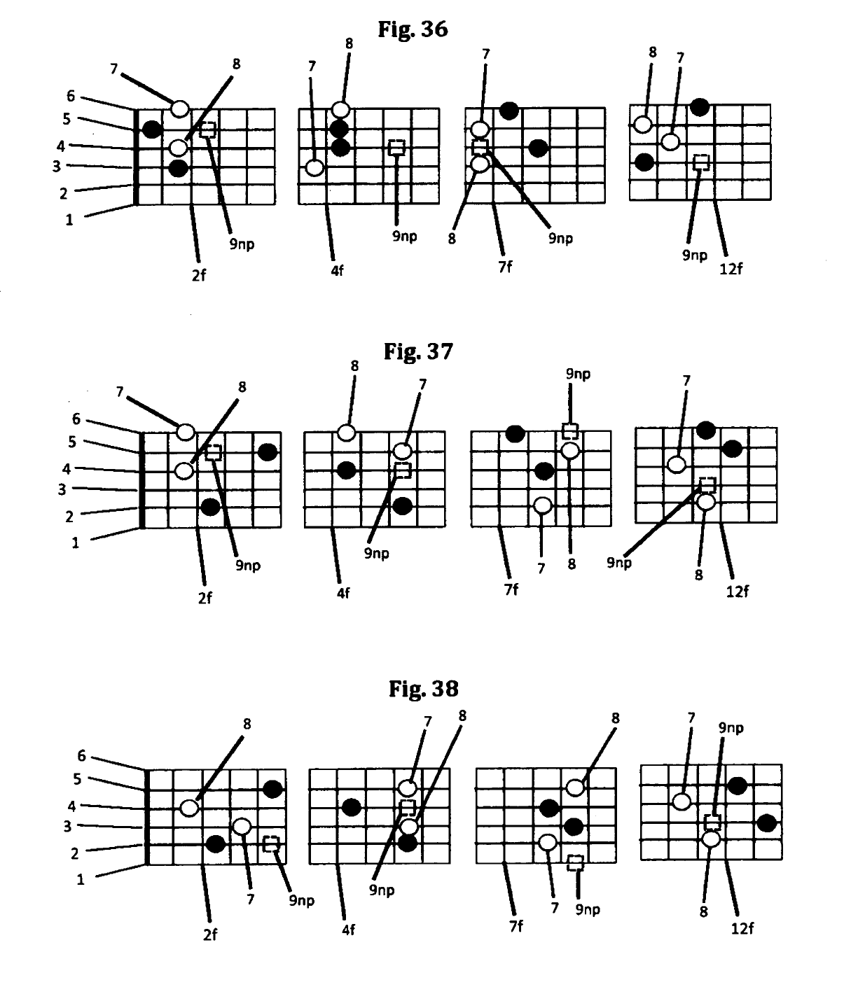

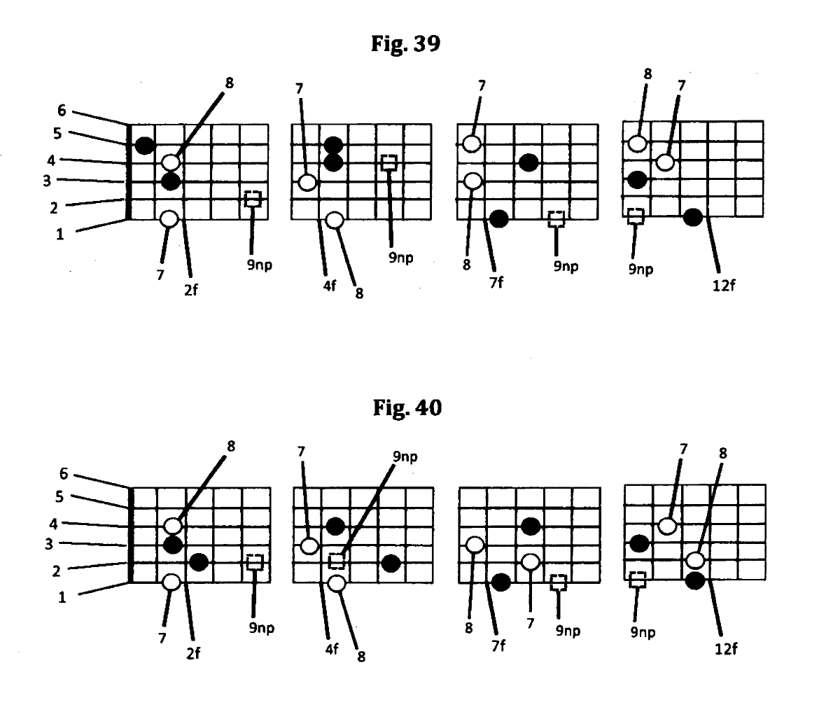

FIGS. 26-30 show a chord on the five string sets and all of its inversions with one root focus. FIGS. 31-35 show a chord on the five string sets and all of its inversions with two root focuses as the notes in this chord have the ability to create two different chord names in common. (A6 and F# minor & respectively). FIGS. 36-40 show a chord on the five string sets and all of its inversions with three “root focuses” as the notes in this chord have the ability to create three different chord names. (D9, F#m7b5, and Am6 respectively). The D9 “Root focus” is not played physically, but used only as a point of reference.

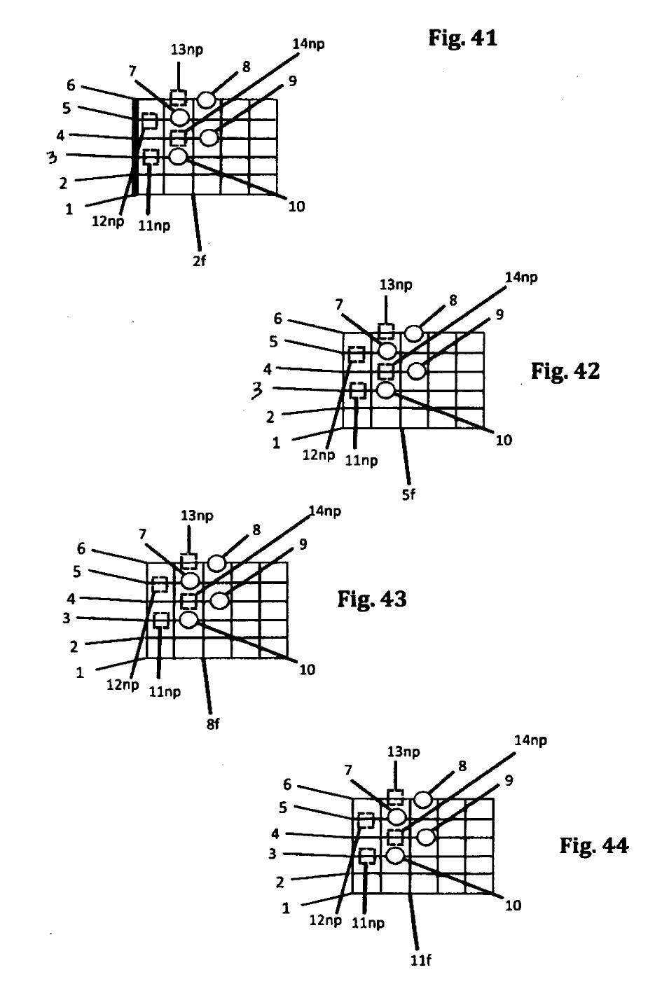

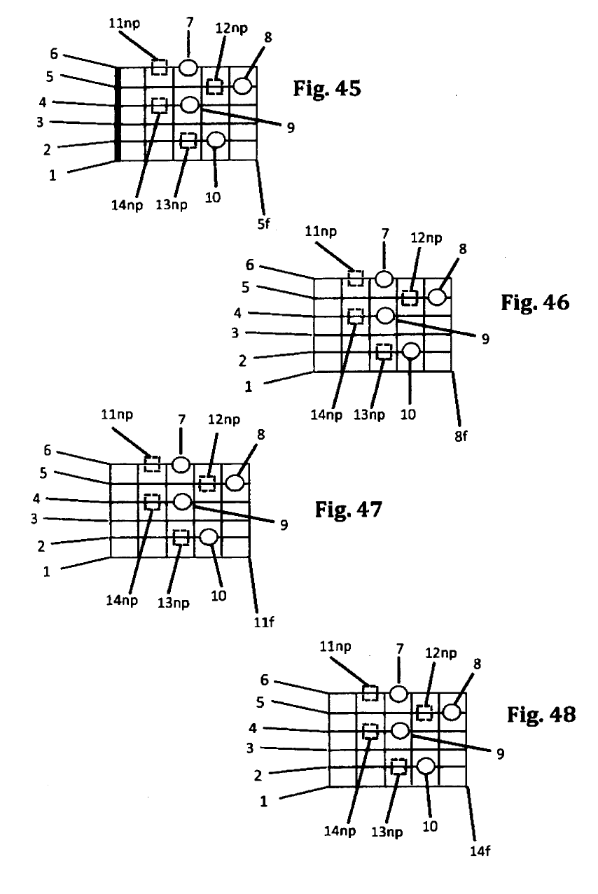

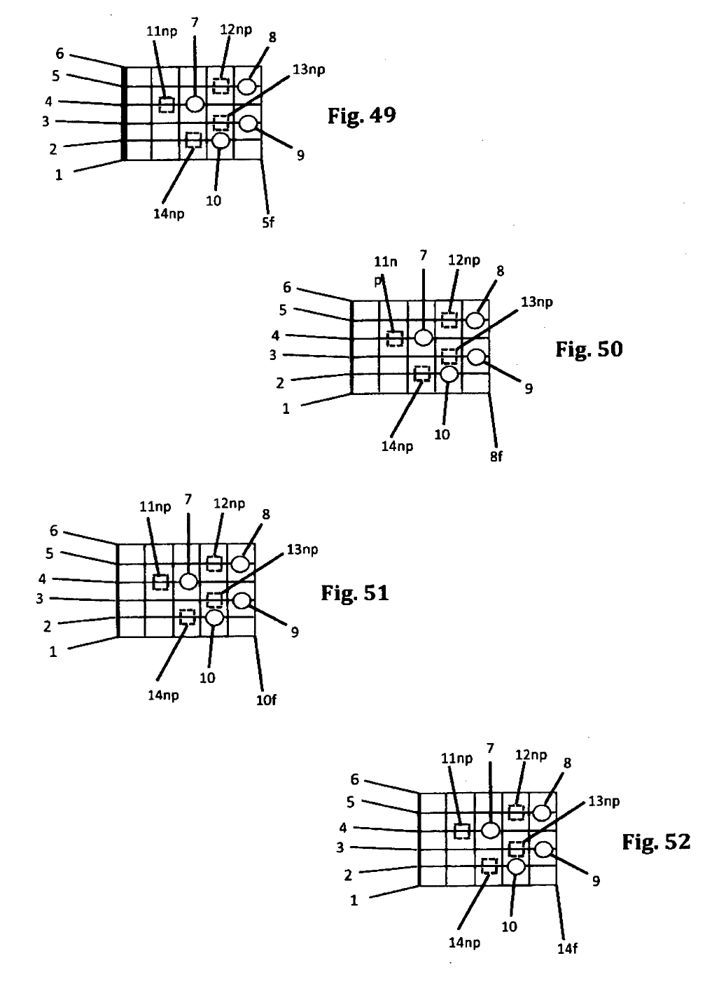

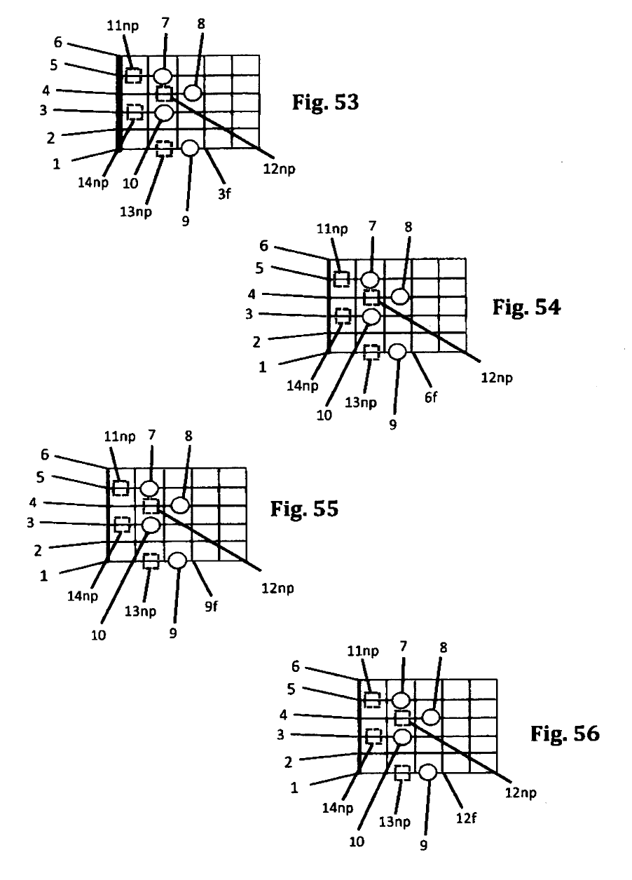

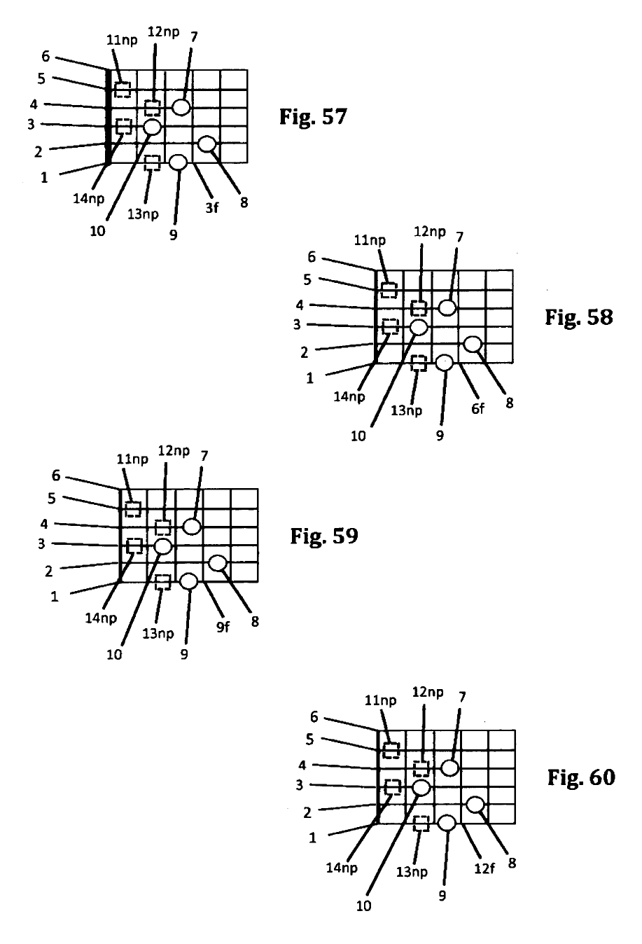

FIGS. 41-60 show a chord on the five string sets and all of its inversions with eight “root focuses” as the notes in this chord have the ability to create eight different chord names. (Db diminished, G dim., E dim., Eb7b9, A7b9, C7b9, F#7b9 respectively). The 7b9 “root focuses” are not played physically, but used only as a point of reference.

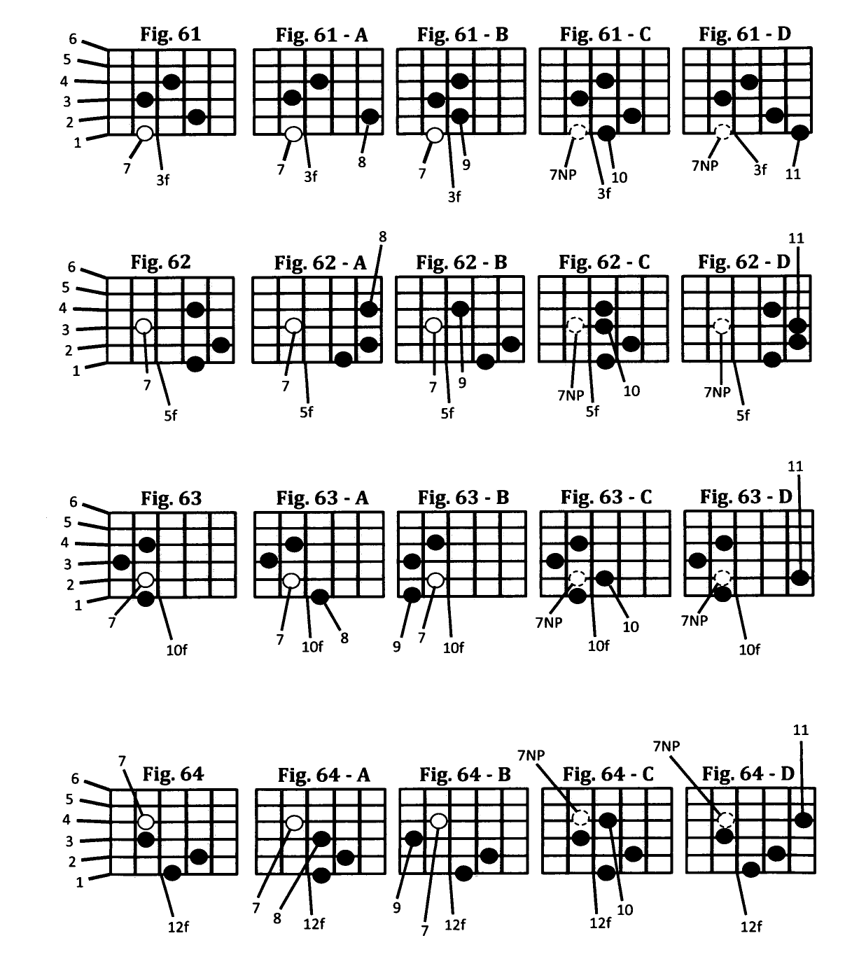

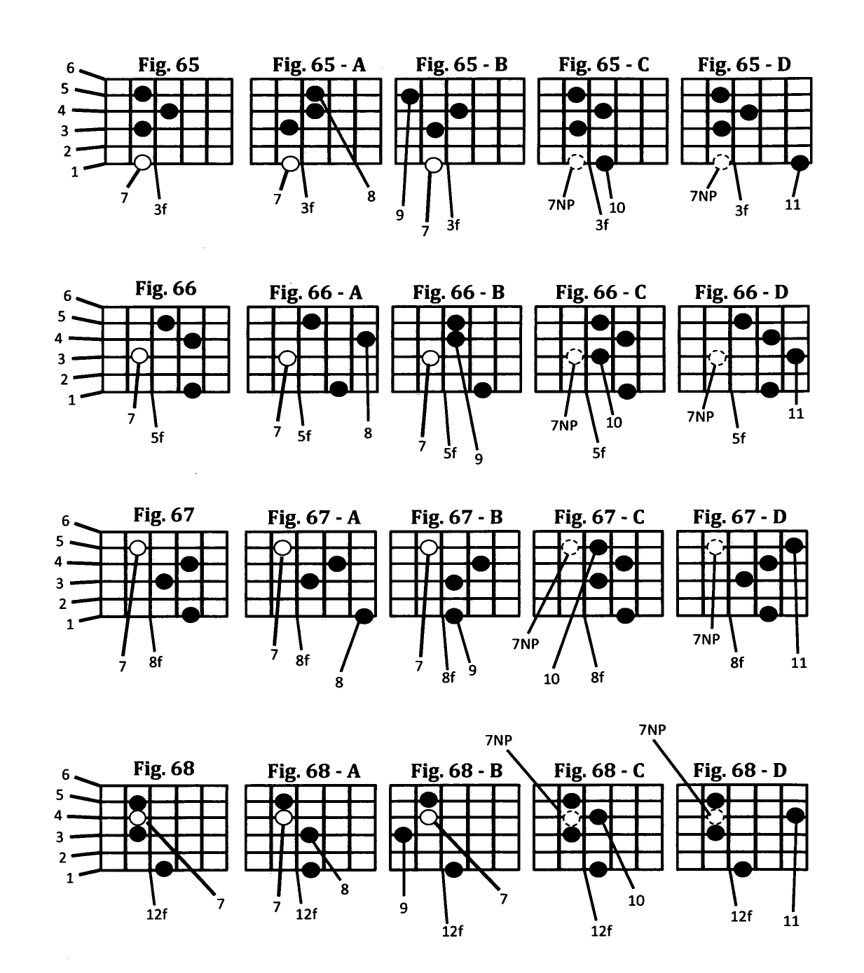

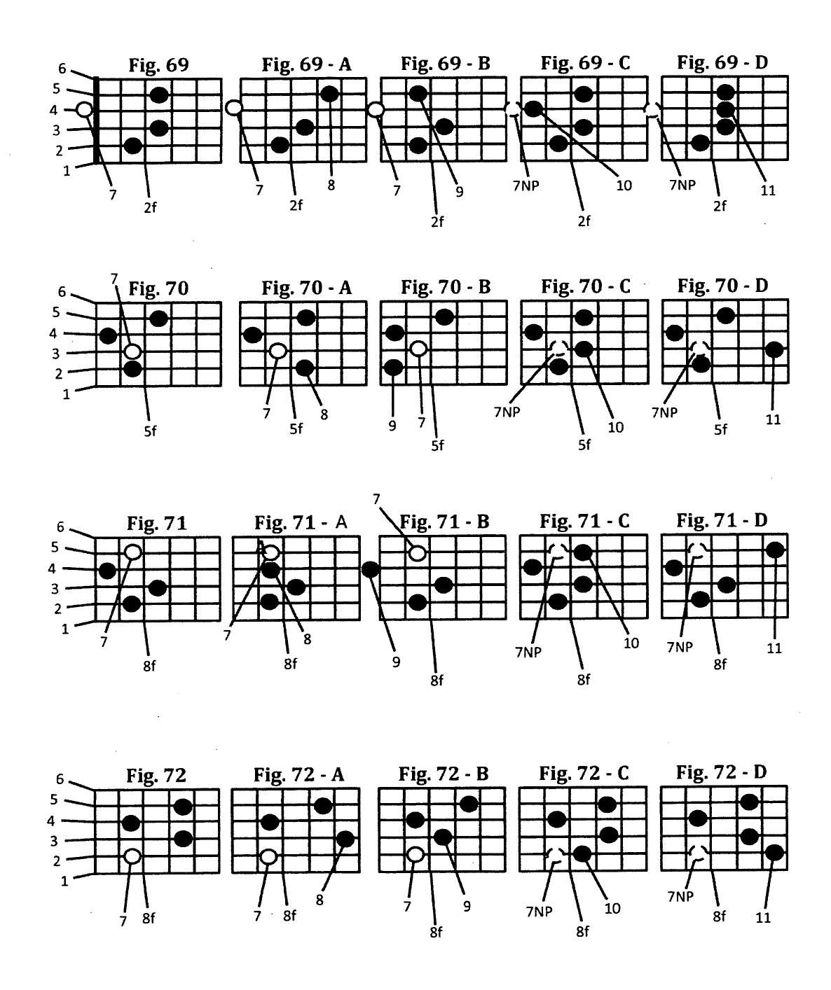

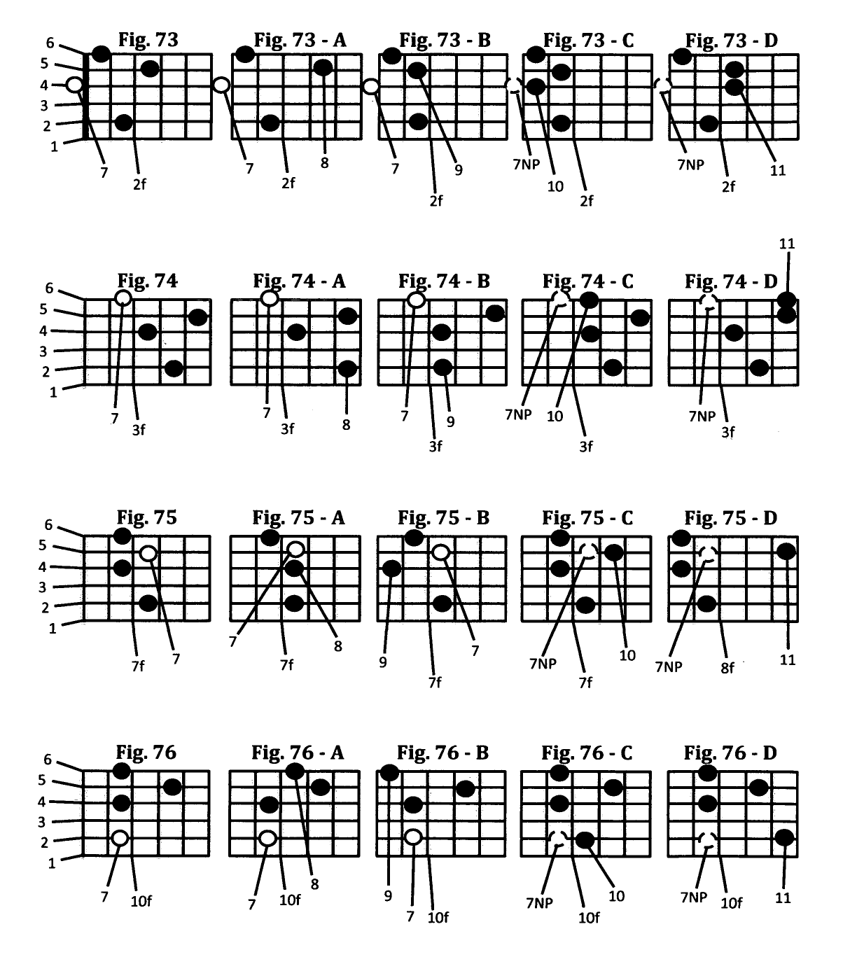

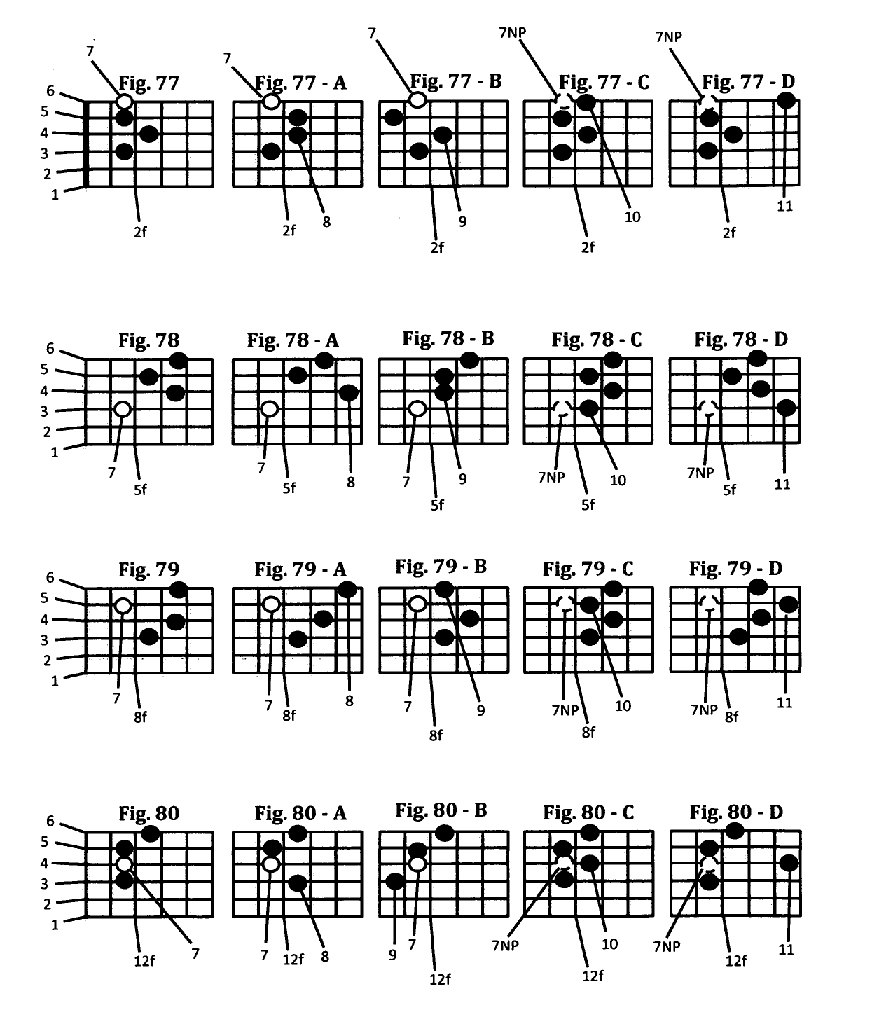

FIGS. 61-80 show a dominant 7^{th} chord on the five string sets and all of its inversions with the #5, b5, b9, and #9. the b9 and #9 “root focuses” are not played physically, but used only as a point of reference.

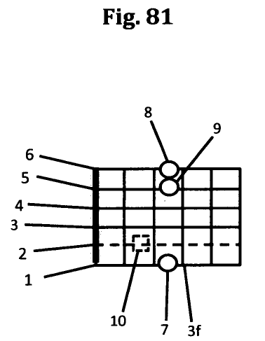

FIG. 81 shows an “open” major chord. This chord contains a “muted” 3^{rd} (10). The 3^{rd} is one of three main elements (1, 3, and 5) of a Major chord. Muting the 3^{rd} means to deaden the string (item 2 with the dashed line to represent the muted string) so it is inaudible to the listener. The student places his or her finger on item 2 just enough to mute or “deaden” the string. The result is that the only notes heard are the “root” (4)(7) and (8) or “one” in numerical terms which in this case are “G” notes, and the 5^{th} (3)(9) which are both “D” notes. By letting only G's and D's ring, the student achieves a “droning” sound, or “Indian” type sound which when used in a “rock” situation with the proper equipment brings forth a specific sound that rock enthusiasts enjoy.

I claim:

1. A method for commercial stringed instrument instruction comprising the steps of:
a. organizing chord inversions into a set of recognizable diagrams;
b. using the diagrams to teach the student repeating patterns of chord inversions along a neck;
c. using the diagrams to teach the student alternatives of chord inversions at different string groupings;
d. using said patterns and said alternatives to improve knowledge of the chord inversions rapidly available to the human hand from any particular point on the neck.

2. The method of claim 1 wherein chord progressions are used to integrate the student's knowledge of step b and step c.

3. The method of claim 1 wherein step b comprises the sub-steps of
a. cyclical practice of fingering the same pattern at different points of the neck to produce different chords;
b. changing the pattern of fingered strings; and
c. cyclical practice of fingering the changed pattern at different points of the neck to produce different chords using the changed pattern.

4. The method of claim 3 wherein chord progressions are used to integrate the student's knowledge of step b and step c.

5. The method of claim 4 wherein interactive tutorials of the steps are stored on computer media for sale.

6. The method of claim 4 wherein interactive tutorials of the steps are presented as televised programming.

7. The method of claim 1 wherein interactive tutorials of the steps are stored on computer media for sale.

8. The method of claim 1 wherein interactive tutorials of the steps are presented as televised programming.
